(19) United States
(12) Patent Application Publication
(10) Pub. No.: US 2009/0184229 A1
(43) Pub. Date: Jul. 23, 2009

(54) ISOLATION MOUNTING APPARATUS

(75) Inventor: James D. Peltier, Albuquerque, NM (US)

Correspondence Address: Caterpillar Inc.;Intellectual Property Dept., AH 9510, 100 N.E. Adams Street, PEORIA, IL, 61629-9510, US

(73) Assignee: CATERPILLAR INC., Peoria, IL (US)

(21) Appl. No.: 12/016,440

(22) Filed: Jan. 18, 2008

(51) Int. Cl. F16M 13/00

(52) U.S. Cl. 248/634

(57) ABSTRACT

An isolation mounting apparatus is disclosed that includes a first resilient mounting pad, a second resilient mounting pad, a substantially rigid mounting plate, and a second substantially rigid mounting plate. The first resilient mounting pad is positioned between the mounting plate and a support component to limit the vibration transmitted from the support component to another component mounted onto the isolation mounting apparatus, and vice versa.

### TECHNICAL FIELD

This disclosure relates generally to a vibration isolation mounting apparatus and more particularly to an isolation mounting apparatus having a multi-layer isolation mount connecting a first component to a support component.

### BACKGROUND

Many internal combustion engines include a turbocharger to pressurize or boost the amount of air flowing into the cylinders of the engine. The additional air in a cylinder permits the combustion of additional fuel in the cylinder. The combustion of additional fuel increases the power generated by the engine. Generally, an internal combustion engine produces more power with a turbocharger than without a turbocharger.

Turbochargers typically include a turbine connected to a compressor. The turbine includes a turbine wheel configured to spin inside a turbine housing. The compressor includes a compressor wheel adapted to spin inside a compressor housing. The turbine wheel is connected to the compressor wheel via a common shaft. The turbocharger is mounted near the exhaust manifold of the engine. The exhaust gases from the engine pass through the turbine housing. The exhaust gases cause the turbine wheel to spin, thus causing the compressor wheel to spin. The spinning compressor wheel pressurizes the intake air flowing through the compressor housing to the cylinders in the engine.

Many turbochargers are mounted on an internal combustion engine by bolts or similar mounting mechanism. The bolts typically pass through holes in a turbocharger base or flange and screw into holes in the internal combustion engine. The connection between the turbocharger base and the internal combustion engine may be mismatched such as when the turbocharger base and engine are uneven, when the holes on the turbocharger base do not align with the holes in the engine, and the like. The turbocharger may be mounted on the engine when the turbocharger base and engine are mismatched. The mismatched connection may create mechanical or installed stresses in the turbocharger and mounting mechanism. Additionally, the direct connection between the turbocharger base and the engine allows vibration from the operation of the engine to be directly transferred to the turbocharger housing and other turbocharger components. Such vibrations put stresses on bellows connections between the exhaust manifold of the engine and the turbocharger housing, as well as on fluid lines (oil/water) that interconnect the turbocharger to other components.

In addition, hot exhaust gases may cause thermal stresses during operation of the turbocharger. The exhaust gases may raise the temperature of the turbocharger up to about 1500 degrees Fahrenheit (815° C.) or more. The temperature increase causes thermal expansion of the turbocharger. The temperature decreases when the turbocharger stops operating. The temperature decrease causes thermal contraction of the turbocharger. The thermal expansion and contraction creates thermal stresses within the turbocharger and affect the connection between the engine and the turbocharger base, as well as the bellows and fluid lines, such as was described above.

These installed and thermal stresses may cause cracking, fatigue, fracture, or other failure of the turbocharger structure. The installed and thermal stresses may increase shear forces or side loads on the mounting bolts or mounting mechanism. The thermal and installed stresses may be more pronounced in dual turbochargers, larger turbochargers such as turbochargers used in diesel engines, and in other turbochargers with a larger or longer connection area with the engine. The size and type of connection area may increase the effect of thermal stresses and may increase the potential for mismatch of the turbocharger with the engine.

Some turbocharger assemblies utilize a single-mounting mechanism, where a supporting portion of the turbocharger is mounted on the internal combustion engine. The supporting portion of the turbocharger may be difficult or awkward to install as a unit and may increase the engine assembly time if installed separately. The uneven support of the supporting portion of the turbocharger and the engine may increase the maintenance of the turbocharger. In addition, the installation of a turbocharger assembly may not be rigid enough to adequately support the turbocharger, and particularly a single-mounted dual-turbocharger, against engine and turbocharger vibration energy. The noise vibration and harshness may be transmitted to the vehicle and operator.

One example of a device used to isolate the turbocharger assembly is disclosed in U.S. Pat. No. 5,624,099 to Spies, et al. Spies discloses an apparatus for mounting a turbocharger housing including an intake pipe on an internal combustion engine. The apparatus includes a clamping element that has a first spring element and a second spring element arranged in series. The clamping element connects the housing to the internal combustion engine so as to allow relative vibration between the housing and the internal combustion engine. The first spring element includes at least one annular spring member made of an elastomeric material. The second spring element includes at least four disk springs, each said disk spring being oriented in a direction opposite to that of an adjacent disk spring. Also included is a clamping screw wherein the second spring element is compressible by the clamping screw such that a spring rate of the second spring element, after compression to an intended preload, is substantially zero. The clamping screw is connectable to a crankcase of the internal combustion engine. Finally, a sealing element of an elastic material connecting the intake pipe to a cylinder head of the internal combustion engine is also included.

The Spies apparatus is a complicated device requiring numerous components, a complex assembly process, substantial adjacent structure and support to properly isolate the engine vibration from the turbocharger assembly. However, due to the reliance on adjacent components for support, there is the potential for vibration to be transferred between these other components as well. It would be advantageous to provide an isolation mounting apparatus with a less complex design that also performs vibration isolation independently of other supporting mechanisms and structures. It would also be advantageous to provide an isolation mounting apparatus that is easy to install, maintain and replace as necessary.

The present disclosure is directed to overcoming one or more of the issues set forth above.

### SUMMARY OF THE DISCLOSURE

The present disclosure is directed to an isolation mounting apparatus that includes a first resilient mounting pad, a second resilient mounting pad, a substantially rigid mounting plate, and a substantially rigid containment plate. The first resilient mounting pad is positioned between the mounting plate and a support component to limit the vibration transmitted from the support component to another component mounted onto the isolation mounting apparatus, and vice versa.

The present disclosure is also directed to a vibration isolation method. The method includes the steps of providing a first component, providing a second component, and providing an isolation mounting apparatus between the first component and the second component. The isolation mounting apparatus includes a first resilient mounting pad, a second resilient mounting pad, a substantially rigid mounting plate, and a substantially rigid containment plate. The method also includes positioning the isolation mounting apparatus substantially between the first component and the second component, and assembling the first component to the second component and securing the isolation mounting apparatus substantially between the first component and the second component to isolate the vibrations between the first component and the second component.

### BRIEF DESCRIPTION OF THE DRAWINGS

FIG. 1 is a perspective view of an assembly having a portion of a turbocharger assembly, a support component, and an isolation mounting apparatus.

FIG. 2 is an exploded perspective view of the isolation mounting apparatus of FIG. 1.

FIG. 3 is a partial cross-sectional view of the isolation mounting apparatus shown in FIGS. 1 and 2.

### DETAILED DESCRIPTION

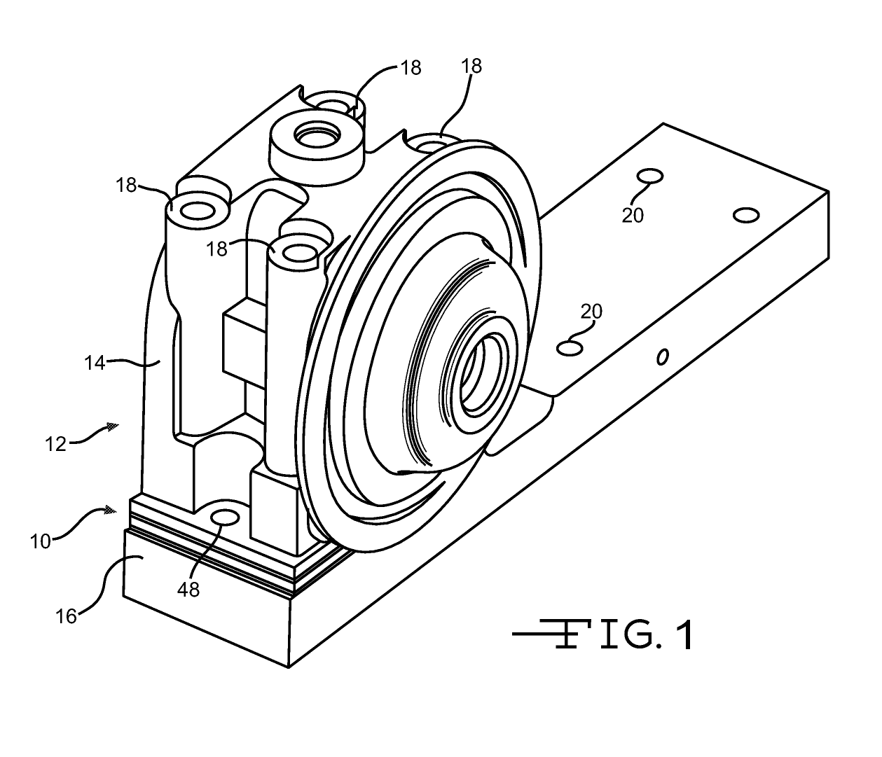

Referring now to the drawings, FIG. 1 provides a schematic view of a portion of an engine assembly. In particular, shown in FIG. 1 is the isolation mounting apparatus, indicated generally at 10, according to the present disclosure. Also shown in FIG. 1 is a portion of a turbocharger assembly 12, and more particularly a turbocharger bearing housing 14. A complete turbocharger assembly is not shown for the sake of clarity but it should be understood that a complete turbocharger assembly could be mounted using the mounting apparatus described herein. The turbocharger assembly 12 is mounted onto a support component, represented schematically at 16. Although as shown, the support component 16 is a frame member, such as an I-beam, it should be appreciated that the support component can be an engine, if the utility is a vehicle application, some other type of structural member, for example a frame member used with a stationary power generation apparatus, or any other component or element that is suitable for supporting the turbocharger assembly 12.

As can be seen in FIG. 1, the turbocharger assembly 12 is connected to the support component 16 via the mounting apparatus 10. The turbocharger housing 14 includes a plurality of tubes 18 that are integrally formed within the housing 14. The tubes 18 are configured to receive and support fasteners 21 that pass through the tubes 18 and connect to the apertures in the isolation mounting apparatus 10. The fasteners permit the housing 14 to be releasably affixed to the isolation mounting apparatus 10. In turn, the isolation mounting apparatus 10 is connected to the support component 16 by fasteners 23. The fasteners 23 pass through the apertures 32, 40, and 48 and openings 20 in the support component 16. The fasteners permit the isolation mounting apparatus 10 to be releasably affixed to the support component 16.

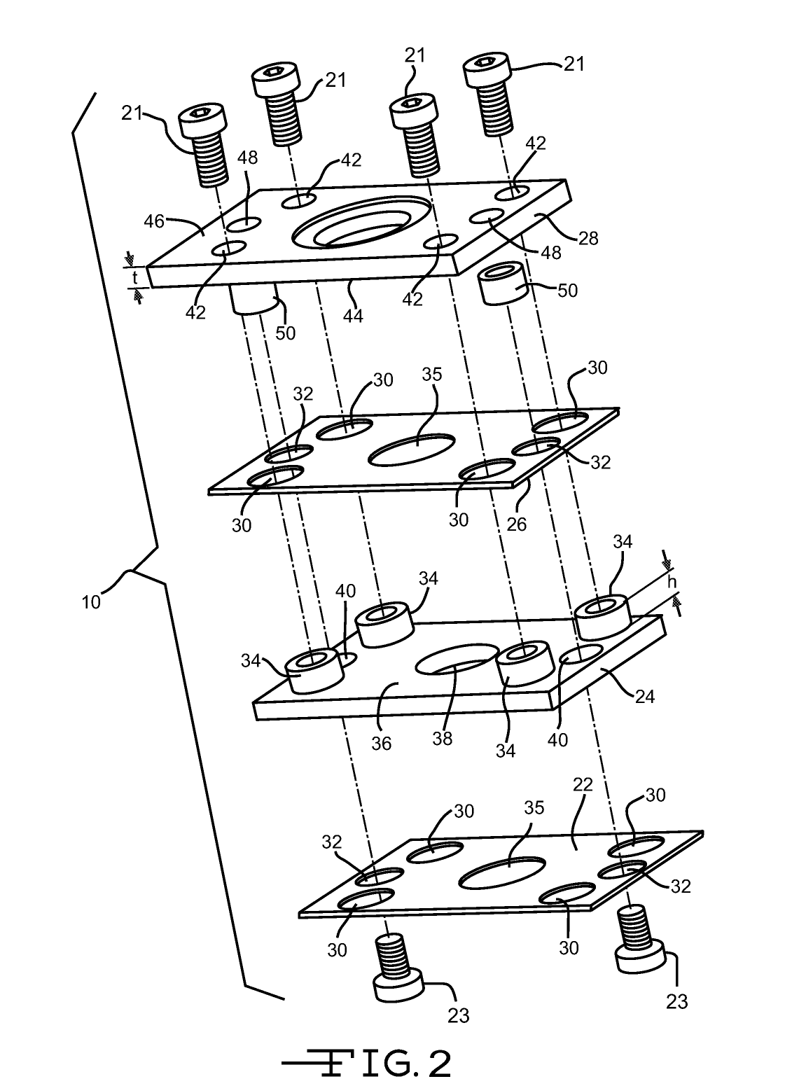

It can be appreciated by one skilled in the art that any suitable fasteners 21, 23 can be used to connect the turbocharger assembly 12 to the isolation mounting apparatus 10, and to connect the isolation mounting apparatus 10 to the support component 16, including, for example, bolts, rivets, pins, screws, and dowels, or any other similar or suitable connecting device. In addition, although the fasteners 21 and 23 are shown being installed in FIG. 2 in a particular orientation, it can be appreciated that the fasteners 21 and 23 can be oriented in any suitable orientation. Additionally, although the fasteners 21 and 23 are shown in FIG. 2 as having a certain length, it can be appreciated that the fasteners 21 and 23 can have any length as necessary to be used in accordance with the present disclosure. It can also be appreciated that welding or other more permanent fixture mechanisms can also be used to make these connections. However, it should also be appreciated that, according to the present disclosure, the isolation mounting apparatus is positioned substantially between the housing 14 and the support component 16.

Illustrated in FIG. 2, an exploded perspective view of the isolation mounting apparatus 10 is shown. The apparatus 10 includes a first resilient mounting pad 22, a substantially rigid floating mounting plate 24, a second resilient mounting pad 26, and a substantially rigid containment plate 28. The first and second resilient mounting pads 22, 26 are substantially similar and will be described next. Each mounting pad 22, 26 is resilient and is made from a fluoroelastomer material. As shown, the mounting pads 22, 26 are a fluoroelastomer material commercially available under the trade name VITON® from DuPont Performance Elastomers. However, one skilled in the art can appreciate that any similar material can be used for the purposes described herein. Additionally, it can be appreciated that the precise resilience of the fluoroelastomer material can be varied depending on the specific application in which the isolation mounting apparatus 10 is being used. Although the mounting pads 22, 26 are shown as being relatively thin sheets of material, it can be appreciated that the mounting pads 22, 26 can have any desired thickness, again depending on the specific application in which the isolation mounting apparatus 10 is being used, and the amount of vibration that is required to be isolated.

The first and second resilient mounting pads 22, 26 have a plurality of first apertures 30 and second apertures 32 formed therein. The utility of these apertures 30, 32 will be described in greater detail below. Each of the mounting pads 22, 26 also have an optional central bore 35 formed therein. The central bore 35 is designed to reduce the overall weight of the isolation mounting apparatus 10. The central bore 35 can also be designed to allow a fluid connection to be made between the turbocharger assembly 12 and the engine (not shown) to permit the flow of gases from the engine to the turbocharger assembly 12. Alternatively, the central bore 35 can be used as a guide for other fluid connections, such as oil and water lines.

The floating mounting plate 24 is a substantially rigid plate that is configured to provide structural support for the connection between the turbocharger assembly 12 and the support component 16. The mounting plate 24 can be made out of any material that is suitable to withstand the conditions surrounding the operation of the turbocharger assembly 12 and engine (such as high temperatures, high pressures, and vibration). In the illustrated embodiment, the mounting plate is made of steel. The mounting plate 24 includes a plurality of projections 34 formed on and extending away from an upper surface 36 of the mounting plate 24. The projections 34 each have a substantially equal height, h. The projections 34 are sized and shaped (outer diameter) to fit within the first apertures 30 formed in the second mounting pad 26, as oriented in FIG. 2. The projections 34 are also adapted to fit within first apertures 42 formed through the containment plate 28, as will be described in greater detail below. The projections 34 provide the mounting surface and fixturing of the turbocharger base surface. The mounting plate 24 also includes a central bore 38 corresponding to the central bore 35 of the first and second mounting pads 22, 26, and for the same reasons.

The containment plate 28 is also substantially rigid and made from similar materials to the mounting plate 24 for the reasons set forth above. The containment plate 28 has a lower surface 44 and an upper surface 46 defining a thickness, t. As stated above, the containment plate 28 also includes a plurality of first apertures 42 formed through it. The first apertures 42 of the containment plate 28 correspond in size and shape (outer diameter in the illustrated embodiment) to the projections 34 formed on the mounting plate 24.

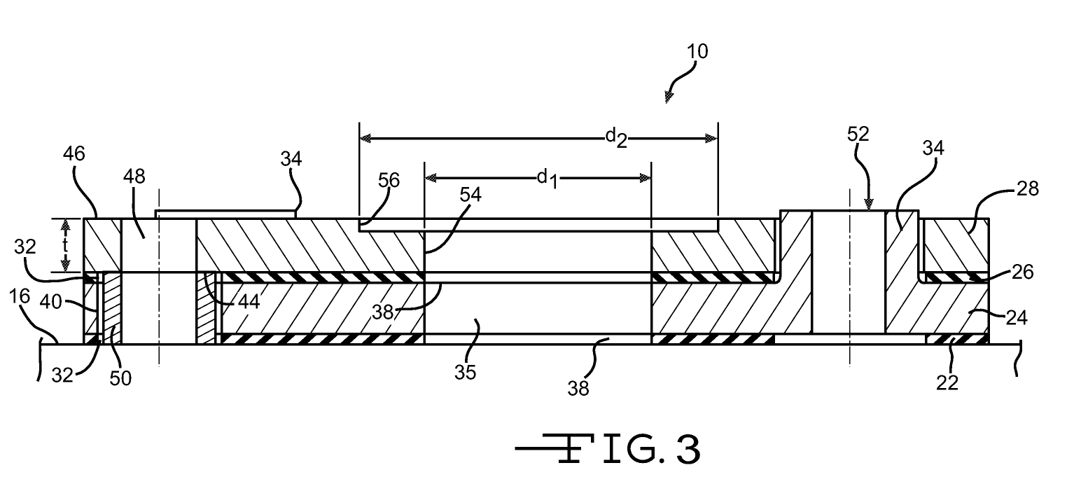

The containment plate 28 also includes a plurality of second apertures 48 formed through it. However, as can be seen more clearly in FIG. 3, the second apertures 48 have a bore outer diameter that is less than the bore diameters of the second apertures 32 formed in the first and second mounting pads 22, 26, and the second apertures 40 formed in the mounting plate 24. However, each of the second apertures 32, 40 are substantially concentric with the second apertures 48 formed in the containment plate 28.

Positioned within each second aperture 32 of the first and second mounting pads 22, 26 and each second aperture 40 of the mounting plate 24, is a load stop member 50. The load stop member 50 is a generally hollow, cylindrical, rigid component having an outer diameter that fits within the apertures 32 and 40. The load stop member 50 inner diameter is substantially the same as the outer diameter of the second apertures 48 of the containment plate 28. Therefore, the top of the load stop member 50 will rest against the lower surface 44 of the containment plate 28. This will help retain the load stop member 50 within the isolation mounting apparatus 10. The purpose of this feature is to rigidly locate the upper containment plate 28 that limits the motion of the floating mounting plate 24.

The containment plate 28 also includes a central bore 54 that extends through the containment plate 28. The outer diameter, d1, of the central bore 54 is substantially the same as the diameters of the central bores 38 and 35 formed in the first mounting pad 22, the second mounting pad 26, and the mounting plate 24. However, the central bore 54 only maintains the outer diameter, d1, throughout a portion of the thickness, t, of the containment plate 28. The diameter of the central bore 54 expands to a second larger diameter, d2, through the remaining portion of the thickness, t, of the containment plate 28. Thus, viewing the upper surface 46 of the containment plate 28, it appears that the containment plate 28 has a groove 56 formed thereon. The purpose of the groove 56 is to support and retain a flexible seal, such as an o-ring or other gasket-type device therein (not shown). An o-ring would provide a sealing mechanism between the containment plate 28 and the turbocharger housing 14 for the purposes described below.

As can be seen most clearly in FIG. 3, the isolation mounting apparatus 10 is formed by stacking or sandwiching the first mounting pad 22, the mounting plate 24, the second mounting pad 26, and the containment plate 28. The load stop members 50 are positioned within the second apertures of the respective mounting pads and plates, as was described above. As an installed apparatus, the first mounting pad would be installed adjacent the support component 16. As can be seen in FIG. 3, the outer diameters of the first apertures 30 formed in the mounting pads 22, 26, and the first apertures 42 formed in the containment plate 28 are substantially concentric and aligned within the isolation mounting apparatus 10. The projection 34 formed on the mounting plate 24 has an outer diameter that is smaller than the outer diameters of the first apertures 30 and 42. Each projection 34 also has an inner diameter defining a fastener bore 52. As shown, the fastener bore 52 is threaded such that each fastener used to connect the tubes 18 formed in the turbocharger housing 14 can be passed through the fastener bore 52 and connect to the isolation mounting apparatus 10. Additionally, this allows the turbocharger housing 14 and the isolation mounting apparatus 10 to be releasably connected to the support component 16. It should be appreciated that the fastener bore 52 is not required to be threaded, since other fastening mechanisms can also be used to connect a first component to the isolation mounting apparatus 10. The fasteners 23 would be used to connect the isolation mounting apparatus 10 to the support component 16 through the apertures 32, 40, and 48.

As can also be seen in FIG. 3, the height, h, of each projection 34 is slightly greater than the thickness, t, of the containment plate 28 such that, when assembled, the projections 34 extend above the upper surface 46 of the containment plate 28. The purpose of such a configuration is to allow the turbocharger housing 14 to be positioned slightly above the upper surface 46 of the containment plate 28.

It can be appreciated that the size and shape of the first and second mounting pads 22, 26, and the mounting plate 24 and the containment plate 28 would be adapted to generally correspond to the size and shape of the turbocharger housing 14 or other portions of the turbocharger assembly 12 that support the assembly on the support component 16.

### INDUSTRIAL APPLICABILITY

The industrial applicability of the isolation mounting apparatus 10 described herein should be readily appreciated from the foregoing discussion. The isolation mounting apparatus 10 is designed to control and limit the amount of vibration that is transmitted from the support component 16 to the component assembled adjacent the isolation mounting apparatus 10 (a turbocharger assembly in the illustrated embodiment).

In the isolation mounting apparatus 10 according to the foregoing description, the first resilient mounting pad 22 establishes a “base” for the apparatus 10. This first resilient member provides a floating surface for the support apparatus so that the rigid mounting plate 24 is positioned away from direct contact with the support component. In the situation where the support component is an engine, a vehicle frame member, or a frame support member for another structure, the vibrations from those support components are at least partially attenuated by the first resilient mounting pad. The use of the second resilient mounting pad 26 between the mounting plate 24 and the containment plate 28 limits the vibrational interaction between those two substantially rigid components, thereby further attenuating the vibrations from the support component 16 and mounting plate 24 to the containment plate 28. The first and second resilient mounting pads 22, 26 also will act to attenuate the vibrations that might be transmitted from the first component (turbocharger housing 14) and the support component 16.

The isolation mounting apparatus 10 is also designed to provide limits on the amount of other motion that occurs between a first component and the support component 16. By limiting this motion, less stress is placed on other connection components, such as oil lines, water lines, and exhaust bellows. Such improvements may also have a positive impact on other related components and attachments.

It should be appreciated that although the above description relates to, and the figures depict, a turbocharger assembly being assembled onto an engine, or vehicle via the isolation mounting apparatus, the isolation mounting apparatus can be adapted to function with a variety of components wherein it is beneficial to isolate the vibrations of a first component from a second component. In addition, although the structure is shown as having a first component positioned atop a second component with the isolation apparatus positioned between the components, it should be appreciated that the isolation apparatus can be utilized in a variety of orientations, configurations, and for a variety of purposes, as would be understood by one skilled in the art.

It should also be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. An isolation mounting apparatus comprising:
a first resilient mounting pad;
a second resilient mounting pad;
a substantially rigid mounting plate; and
a second substantially rigid containment plate;
wherein the first resilient mounting pad is positioned between the mounting plate and a support component.

2. The apparatus defined in claim 1 further comprising a first component connected to the support component, wherein the isolation mounting apparatus is positioned between the first component and the support component.

3. The apparatus defined in claim 2 wherein the support component is an engine and the first component includes a turbocharger assembly.

4. The apparatus defined in claim 3 wherein the turbocharger assembly is positioned adjacent the containment plate and is connected to the engine through the isolation mounting apparatus.

5. The apparatus defined in claim 1 further at least one projection formed on the first mounting pad configured to fit within a corresponding at least one first aperture formed in each of the second mounting pad and the containment plate.

6. The apparatus defined in claim 1 further comprising a load stop member positioned within a second aperture formed in each of the mounting pads and the mounting plate and the containment plate.

7. The apparatus defined in claim 1 wherein the support component is a vehicle frame member.

8. A vibration isolation method comprising:
providing a first component;
providing a second component;
providing an isolation mounting apparatus between the first component and the second component, wherein the isolation mounting apparatus further includes a first resilient mounting pad, a second resilient mounting pad, a substantially rigid mounting plate, and a substantially rigid containment plate;
positioning the isolation mounting apparatus substantially between the first component and the second component;
assembling the first component to the second component and securing the isolation mounting apparatus substantially between the first component and the second component to isolate the vibrations between the first component and the second component.

9. The method defined in claim 8 wherein the first resilient mounting pad is positioned between the mounting plate and the second component.

10. The method defined in claim 8 further comprising at least one projection formed on the first mounting pad and at least one first aperture formed in each of the second mounting pad and the containment plate, wherein the projection is configured to fit within each of the first apertures.

11. The method defined in claim 10 further comprising the step:
aligning each of the at least one first apertures with the at least one projection;
guiding the projection through the first apertures to secure the mounting plate to the second mounting pad and the containment plate.

12. The method defined in claim 11 further comprising a load stop member positioned within a second aperture formed in each of the mounting pads, the mounting plate and the containment plate.
